(19) United States
(12) Patent Application Publication
(10) Pub. No.: US 2016/0151874 A1
(43) Pub. Date: Jun. 2, 2016

(54) METHOD OF GRINDING AN INNER SURFACE OF A CYLINDRICAL TANK

(71) Applicant: CKJ STEEL A/S, Koge (DK)

(72) Inventor: Carsten Kenneth Jensen, Faxe (DK)

(73) Assignee: CKJ STEEL A/S, Koge (DK)

(21) Appl. No.: 14/955,921

(22) Filed: Dec. 1, 2015

(30) Foreign Application Priority Data
Dec. 2, 2014 (EP) 14195841.3

(51) Int. Cl. B24B 1/00; B08B 9/032; B08B 9/08; B08B 9/093

(52) U.S. Cl. CPC B24B 1/00; B08B 9/093; B08B 9/032; B08B 9/08

(57) ABSTRACT

A method of grinding an inner surface of a tank that includes convex first and second parts joined by a cylindrical part, the together defining an inner surface, the method including providing a frame for holding the tank and a stand rotatably connected to the frame. Initially, the frame assumes a horizontal position, and an amount of grinding material is placed into the tank covering a part of the inner surface of the tank. Thereafter, the tank is rotated about a central axis, causing the grinding material to move in a sliding and non-tumbling movement relative to the inner surface. The rotation is repeated in a first tilted position and in a second tilted position, wherein the grinding material extends on the inner surface between the cylindrical part and the respective points of interception between the first and second parts and the central axis of the tank.

### CROSS-REFERENCE TO RELATED APPLICATIONS

This application claims the benefit of European application Serial No. 14195841.3, filed on Dec. 2, 2014, the subject matter of which is incorporated herein by reference.

The present invention relates to technologies for grinding an inner surface of a cylindrical tank and cleaning a vessel, such as a tank or pipeline.

### BACKGROUND

In the manufacturing industry, such as chemical industry and pharmaceutical industry, there is a need for vessels for temporarily storing fluids, in particular liquids. The vessels may also be used as reaction chambers when producing e.g. pharmaceutical drugs. In the present context, the term vessel is primarily used in connection with tanks of varying volumes of from some centilitres up to several 1000 litres. The tanks are typically pressure proof and made of metal, such as stainless steel. It is understood that the teachings according to the present invention is equally applicable to pipes and pipelines.

In the above mentioned industries, and in particular in the pharmaceutical industry, the cleanliness of such vessels is important since any dirt may negatively influence the material stored in the vessel. As the vessels may be used under clean room conditions, even very small amounts of dirt may be unacceptable. The dirt may be microscopic in the form of dust, droplets or stains on the inner surface of the vessel. It may also be oxidations on the inner surface and yet further, it may be pieces of a material previously stored in the vessel. Dirt in the present context is understood as any foreign material which is not intended to be present in the vessel. The dirt may e.g. contaminate the material stored in the vessel and thus make the entire batch useless. Further, the dirt may even react with the material in the vessel and possibly result in hazardous reaction products. Thus, the presence of dirt in the vessel constitutes a serious safety concern and in order to reduce the risk of dirt in the vessel a two step procedure is followed:

Firstly, the interior surface of the vessel is being grinded in order to achieve a perfectly smooth surface having a negligible surface roughness. A smooth surface is much easier to keep clean since it is free from any surface roughness which provides small cavities in which dirt may store and accumulate.

Secondly, the vessel is being cleaned by the use of a cleaning fluid. Typically a two step cleaning is performed by first performing a decontamination step and thereafter a passivation step. In the decontamination step, the inner surface of the vessel is degreased by using a weak alkaline solution and thereafter decontaminated by use of a weak acid solution. In the passivation step the inner surface of the vessel is degreased by using a weak alkaline solution and thereafter passivated by use of a strong acid solution.

There exist prior art technologies for both grinding and cleaning vessels.

KR 100986803B1 relates to an apparatus for grinding, washing and drying the interior of a gas tank by the use of grindstone, an abrasive and an anticorrosive. However, the position of the gas tank is not changed during the grinding.

KR 100765814B1 relates to an inner face grinder for a gas tank. A tank loading unit is provided for loading and unloading the gas tank automatically.

KR 1020110010285A relates to an apparatus for cleansing of a composite cylinder. The composite cylinder is rotated, however, not about its own axle.

US 2009/0056751 A1 relates to a method of cleaning the interior walls of a storage tank comprising traversing over said walls a cleaning head.

U.S. Pat. No. 4,827,563 relates to an apparatus for cleaning the inside of tanks of various dimensions comprising a vertically disposed hollow tube inside the tank having a plurality of scrapers.

US 2012/216363 A1 relates to a dry type cleaning case which cleans a cleaning object by causing a cleaning medium to fly by an airflow and contact the cleaning object.

It is thus an object of the present invention to provide technologies for grinding and cleaning vessels.

### SUMMARY OF THE INVENTION

The above need and object together with numerous other needs and objects are according to a first aspect according to the present invention achieved by a method of grinding an inner surface of a cylindrical tank, the cylindrical tank comprising a convex first part, a convex second part and a cylindrical part interconnecting the convex first part and the convex second part, the convex first part, the convex second part and the cylindrical part together defining the inner surface, the cylindrical part defining a central axis, the method comprising the step of providing a grinding assembly, the assembly comprising:

a frame for holding the cylindrical tank and preventing any substantial movement of the cylindrical tank except around the central axis, the frame comprising a motor and a drive mechanism connected to the motor, the drive mechanism being capable of interacting with the cylindrical tank, and

a stand rotably connected to the frame, the stand defining a tilt axis in relation to the frame, the tilt axis being horizontal and perpendicular to the central axis,

the method comprising the additional steps of:

holding the cylindrical tank by the frame and causing the frame to assume a horizontal position in which the convex first part and the convex second part are level,

placing an amount of grinding material into the tank such that the grinding material covers a part of the inner surface and extends between the convex first part and the convex second part,

rotating the cylindrical tank about the central axis by using the motor and the drive mechanism at a rotational speed of less than 100 rpm and causing the grinding material to move in a sliding and non-tumbling movement relative to the inner surface,

causing the frame to assume a first tilted position in which the convex first part is located above the convex second part and the grinding material extends on the inner surface between the cylindrical part and a first point of interception between the convex second part and the central axis,

rotating the cylindrical tank about the central axis by using the motor and the drive mechanism at a rotational speed of less than 100 rpm and causing the grinding material to move in a sliding and non-tumbling movement relative to the inner surface,

causing the frame to assume a second tilted position in which the convex first part is located below the convex second part and the grinding material extending on the inner surface between the cylindrical part and a second point of interception between the convex first part and the central axis,

rotating the cylindrical tank about the central axis by using the motor and the drive mechanism at a rotational speed of less than 100 rpm and causing the grinding material to move in a sliding and non-tumbling movement relative to the inner surface.

The cylindrical tank is typically made of stainless steel. The cylindrical tank comprises a centrally located body portion in the form of the cylindrical part. The convex parts constitute the respective top and bottom of the tank and are typically welded onto the cylindrical part. The tank is typically made pressure proof and capable of withstanding an overpressure. The tank also typically comprises one or more openings in the form of connectors, valves, lids, ports, flanges, manholes, etc which may be welded onto the tank. The inner surface of the newly produced tank thus has a significant roughness due to the welds present on the inner surface. Further, the machining of the tank during manufacture, such as cutting, rolling, pressing, extruding, will also leave marks on the inner surface of the tank. Convex should be interpreted as being curved in an outwardly direction.

The frame for holding the cylindrical tank should secure the tank preventing any substantial movement of the cylindrical tank except around the central axis and thus provide at least one point of fixation on the tank. The central axis is defined by the cylindrical part of the tank and extends between the first point of interception of the convex second part and the second point of interception of the convex first part. The points of interception constitute the centre points of the respective convex parts. The tank should be cylinder symmetric in order to be able to rotate in a well defined manner.

Preferably, the frame holds the tank by bolting any of the points of interception directly to a drive shaft of the drive mechanism. In this way the tank will be prevented from moving in any direction except the rotational direction about the central axis. The frame may be provided with rollers for supporting the weight of the tank. Alternatively, the tank is clamped by rotatable clamps between the two opposing points of interception, thereby also preventing movement in any direction while allowing the tank to rotate about its centre axis. The motor and drive mechanism may provide the rotational movement at one or both points of interception, or by means of rollers at any other point on the outer surface of the tank.

The stand is preferably standing on the ground, such as a factory floor, and providing sufficient stability for the frame and keeping the frame at a sufficient level above the ground for preventing the tank from touching the ground. The stand and the frame are interconnected by means of a tilting arrangement which allows the tilting of the frame. The tiling arrangement is preferably located as close as possible to the centre of gravity of the combined tank and frame in order for the tilting angle to be easily changed. The change of tilting angle may be made manually, or by the use of a motor.

In the first method step, the tank should be kept in a horizontal orientation. An amount of grinding material is inserted into the tank onto the inner surface through an opening in the tank. The amount may vary, however, an area extending the full distance at the lowermost part of the inner surface between the convex first part and the convex second part should be covered. Also, any welds between the convex parts and the cylindrical part should be covered. The tank is then rotated slowly at a rotation speed not exceeding 100 rpm for a period of between 3-4 days during which the inner surface of the tank is being grinded and polished. The grinding material should move in a sliding and non-tumbling movement relative to the inner surface in order to prevent dents in the inner surface. The rotational speed of the tank should thus be kept low enough to avoid producing a centrifugal force which allows the frictional force between the inner surface of the tank and the grinding material to exceed the gravitational force of the grinding material and thus allow the grinding material to tumble. The grinding material should thus remain at the lowest part of the tank as the tank is turning and slow movement between the tank and the grinding material will slowly polish the inner surface of the tank without causing any dent, scratches or other damage to the inner surface.

After 3-4 days the frame is tilted such that the grinding material shifts from the cylindrical part to the convex second part. The tilting depends on the ratio between the length and the diameter of the tank, and should be such that the grinding material accumulates between the cylindrical part and a second point of interception between the convex first part and the central axis. Typical values are between 30 degrees and 60 degrees. After 3-4 days, the process is resumed for the opposite convex first part by tiling the tank in the opposite direction. The full grinding process is typically resumed a second time using a finer grinding material and slightly longer time for each of the positions, typically 5 days. This brings the total grinding to 9-12 days using the coarse grinding material and then 15 days using the fine grinding material totaling 24-27 days.

According to a further embodiment of the first aspect, the motor and the drive mechanism being adapted for rotating the cylindrical tank at 5-100 rpm, preferably 10-60 rpm, more preferably 15-45 rpm, most preferably about 22 rpm. The rotational speed is preferably kept well below the speeds at which the grinding material is tumbling. The tumbling speed is strongly dependent on the friction between the grinding material and the inner surface, which in turn depends on the roughness of the inner surface and the coarseness of the grinding material. It is thus contemplated that the rotation of the new tank may optionally begin at a slow speed which increases slightly after a number of revolutions, since each revolution will have removed some roughness of the inner surface.

According to a further embodiment of the first aspect, the grinding material comprises a mixture of ceramic grinding stones and an aqueous solution. The grinding stones may be commercially available grinding pellets which are suitable for grinding metal. The aqueous solution provides cooling and collects the dust particles generated from the grinding.

According to a further embodiment of the first aspect, the ceramic grinding stones have a shape corresponding to angle-cut cylinders having a length of between 2-20 mm and a diameter of 1-10 mm. The shape and size may be adapted to the size of the tank. Further, finer stones are typically smaller than coarser stones. The above shape prevents tumbling and instead induces a turning motion of the stones which will provide an improved grinding effect.

According to a further embodiment of the first aspect, the aqueous solution comprises a mixture of a soap solution and a weak alkaline solution. The soap provides some lubrication and helps holding the dust particles which are generated from the grinding. The weak alkaline solution helps degreasing the inner surface of the tank.

According to a further embodiment of the first aspect, the amount of grinding material is chosen such that the aqueous solution covers the ceramic grinding stones within the cylindrical tank. In order to fully exploit the above advantages and further to allow the aqueous solution to prevent tumbling of the grinding material, the grinding material should be covering the ceramic grinding stones.

According to a further embodiment of the first aspect, the amount of grinding material is chosen such that the grinding material covering an angular distance perpendicular to the longitudinal distance on the inner surface of the cylindrical part of between 10°-120°, preferably 30°-90°, more preferably 45°-75°, most preferably about 60° C. In order to establish a large grinding area at the bottom of the tank, the above values are preferred. The grinding material will always, due to the gravitational force, settle at the bottom or lowest area on the inner surface of the tank, which area of course depends on the tilt angle and instantaneous rotational angle of the tank.

According to a further embodiment of the first aspect, the frame further comprising a chain, the chain comprising rollers adapted for supporting the cylindrical tank. In order to further support the tank, the frame may comprise a chain having rollers intended to contact and support the tank at the lower outside part of the cylindrical part of the tank. The chain is understood to also encompass belts and similar flexible structures. The chain may even encircle the complete outside part of the cylindrical part of the tank.

According to a further embodiment of the first aspect, the stand and the frame define a number of predefined angles in relation to each other. In this way, it will be easier to determine the horizontal level and there is no or at least limited risk that the tilt angle will change during the processing.

According to a further embodiment of the first aspect, the frame being adjustable in length and width. The sizes of the tanks may vary significantly from a few cm in diameter up to more than a meter in diameter. Thus, the frame is preferably adjustable.

The above need and object together with numerous other needs and objects are according to a second aspect according to the present invention achieved by an assembly for grinding an inner surface of a cylindrical tank, the cylindrical tank comprising a convex first part, a convex second part and a cylindrical part interconnecting the convex first part and the convex second part, the convex first part, the convex second part and the cylindrical part together defining the inner surface, the cylindrical part defining a central axis, the assembly comprising:

a frame for holding the cylindrical tank and preventing any substantial movement of the cylindrical tank except around the central axis, the frame comprising a motor and a drive mechanism connected to the motor, the drive mechanism being capable of interacting with the cylindrical tank for rotating the cylindrical tank about the central axis at a rotational speed of less than 100 rpm, and

a stand rotably connected to the frame, the stand defining a tilt axis in relation to the frame, the tilt axis being horizontal and perpendicular to the central axis, the stand allowing the frame to assume a horizontal position in which the convex first part and the convex second part are level, a first tilted position in which the convex first part is located above the convex second part, and a second tilted position in which the convex first part is located below the convex second part.

It is evident that the assembly according to the second aspect may be used in conjunction with the method according to the first aspect.

The above need and object together with numerous other needs and objects are according to a third aspect according to the present invention achieved by a mobile system for cleaning a vessel, the vessel preferably being a tank or a pipeline, the system comprising:

a first trolley comprising an internal reservoir for accommodating between 50 litres and 1000 litres of cleaning fluid, and a fluid connector for connecting to the internal reservoir from the outside of the first trolley, the first trolley further comprising a heating system for heating the cleaning fluid within the internal reservoir,

a second trolley comprising a conduit between a fluid inlet having an inlet valve and being connectable to the fluid connector of the first trolley and a fluid outlet having an outlet valve and being connectable to the vessel, the conduit comprising a pump connected to the fluid inlet for pumping cleaning fluid from the internal reservoir of the first trolley via the fluid inlet and fluid outlet to the vessel, the second trolley further comprising a relief valve for relieving the conduit of any excessive pressures, a pressure measurement device for measuring the pressure within the conduit, a temperature measurement device for measuring the temperature within the conduit, a flow measurement device for measuring the flow of cleaning fluid through the conduit, and a processing unit for receiving the measured pressure, temperature and flow,

the first trolley and the second trolley each having at least 2 wheels, preferably at least 3 wheels, more preferably at least 4 wheels, and each having a height and a width being less than the height and width of a standard residential door.

The above system is used for the cleaning of vessels. It may preferably be used for the cleaning which is performed after the grinding of the tank according to the first and second aspects, however, it may also be used for periodical cleaning of tanks and piping at the manufacturing plant. The above trolleys are made small enough to be transported in an indoor environment having a size which makes them able to pass through a standard residential door, which typically measures 0.9-1 m in width and 2.1 m in height. The present trolleys are typically moved by human power, however, a small electrical motor may be used for simplifying the moving. Each trolley typically has 4 wheels, which may be of the swivel type, in order to maximize both stability and maneuverability.

The first trolley holds the cleaning fluid. The cleaning fluid may be de-ionised and/or distilled water, a weak alkaline solution, a weak acid solution or a strong acid solution, depending on the type of cleaning to be performed. Water is typically used for flushing after the cleaning and between using the other cleaning fluids. Alkaline solutions, such as NaOH are typically used for degreasing, weak acid solutions such as citric acid for decontamination and strong acid solutions such as HNO₃ for passivation. The first trolley comprises one or more connectors at the lower end of the internal reservoir in order to be able to extract the cleaning fluid from the internal reservoir. Further a heating system comprising one or more heating elements is included in the inner volume for heating the cleaning fluid. The heating elements are preferably electrical heating modules which are powered by the electrical mains.

The second trolley is connectable to the first trolley in order to pump the cleaning fluid from the internal volume of the first trolley to the vessel which is intended for cleaning. The second trolley measures the flow of cleaning fluid, the pressure of the cleaning fluid and the temperature of the cleaning fluid. The values are received by the processing unit. The second trolley may comprise a printer for printing the received values. Further, the second trolley may comprise a removable storage media for storing the values, or a connection to the internet for uploading the values. The pressure value may be used to control the pump and/or the relief valve. The temperature may be used for regulating the heating system on the first trolley. The flow value may be used for determining the length of the cleaning process. The second trolley may be powered by the electrical mains.

It is contemplated that the assembly may also include a return line in order to allow the cleaning fluid to flow from the vessel back into the internal volume of the first trolley. Thus, a closed circuit is established. After the cleaning has been performed, the cleaning fluid may be pumped over to a separate tank and another cleaning fluid may be used in the intern al volume.

According to a further embodiment of the third aspect, the second trolley further comprising a conductance measurement device for measuring the conductance of the cleaning fluid and/or a pH measurement device for measuring the pH of the cleaning fluid. In this way, the progress of the cleaning may be monitored by measuring the change in pH and/or conductance of the cleaning fluid.

According to a further embodiment of the third aspect, the internal reservoir is made up of at least two separate compartments having separate fluid connectors and heating systems, the compartments preferably constituting one large compartment and one small compartment, and/or the internal reservoir comprises a stirrer.

To be able to efficiently clean both small and large tanks and piping, the internal volume may be separated into several compartments. In this way, the amount of heated cleaning fluid may be adapted to the size of the vessel. In this way both cleaning fluid and energy may be saved. Alternatively, the compartments are used for different kinds of cleaning fluid, thereby eliminating the need for changing cleaning fluid.

Further, the internal volume may be provided with a stirrer in order to mix the cleaning fluid.

The above need and object together with numerous other needs and objects are according to a fourth aspect according to the present invention achieved by a process of cleaning a vessel, the vessel preferably being a tank or a pipeline, the process comprising:

providing a first trolley comprising an internal reservoir accommodating between 50 litres and 1000 litres of cleaning fluid, and a fluid connector for connecting to the internal reservoir from the outside of the first trolley, the first trolley further comprising a heating system for heating the cleaning fluid within the internal reservoir,

providing a second trolley comprising a conduit between a fluid inlet having an inlet valve and being connected to the fluid connector of the first trolley and a fluid outlet having an outlet valve and being connected to the vessel, the conduit comprising a pump connected to the fluid inlet, the second trolley further comprising a relief valve for relieving the conduit of any excessive pressures, a pressure measurement device for measuring the pressure within the conduit, a temperature measurement device for measuring the temperature within the conduit, a flow measurement device for measuring the flow of cleaning fluid through the conduit, and a processing unit for receiving the measured pressure, temperature and flow, the first trolley and the second trolley each having at least 2 wheels, preferably at least 3 wheels, more preferably at least 4 wheels, and each having a height and a width being less than the height and width of a standard residential door, and

pumping cleaning fluid from the internal reservoir of the first trolley via the fluid inlet and fluid outlet to the vessel by using the pump.

It is evident that the process according to the fourth aspect may be used together with the system according to the third aspect.

### BRIEF DESCRIPTION OF THE DRAWINGS

FIG. 1 is an assembly for grinding an inner surface of a cylindrical tank.

FIG. 2 is the assembly for grinding of FIG. 1 without the tank.

FIG. 3A-3B is a perspective interior view of an assembly for grinding an inner surface.

FIG. 4 is a perspective view of an assembly, showing the degrees of freedom.

FIG. 5A-C are side views of the assembly, illustrating three respective tilt angles.

FIG. 6A-E are views of a pump trolley.

FIG. 7A-E are views of a tank trolley.

FIG. 8 is a side view of a cleaning system.

FIG. 9 is a schematic view of a cleaning system.

### DETAILED DESCRIPTION OF THE DRAWINGS

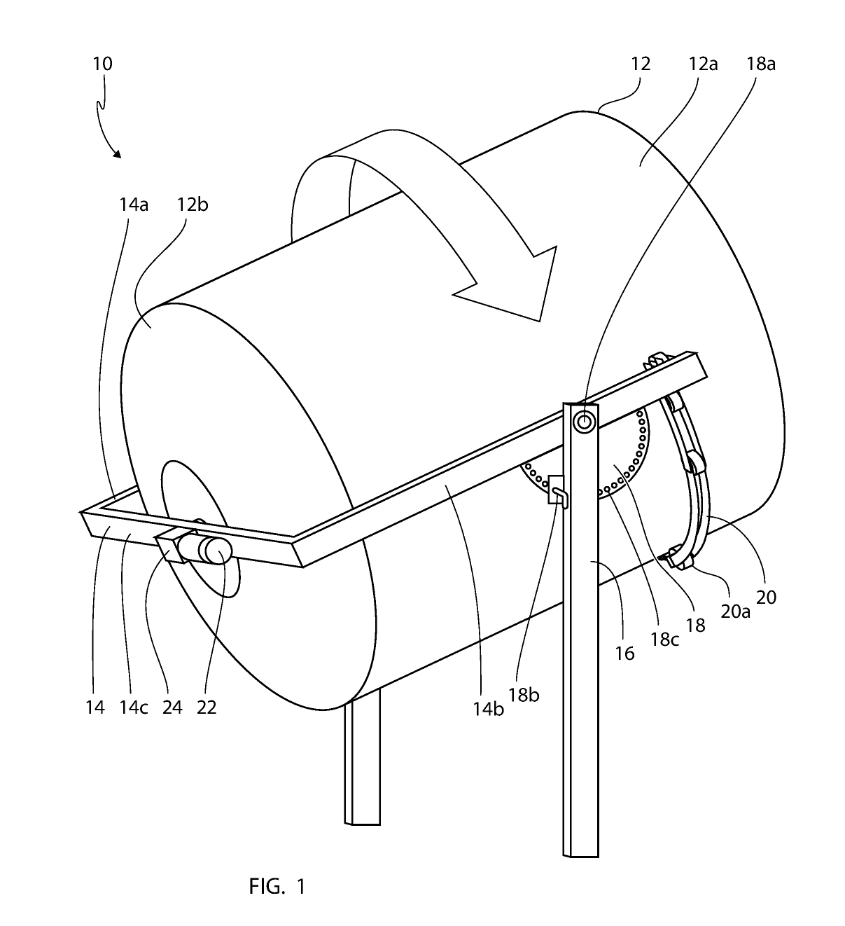

FIG. 1 shows a perspective view of an assembly 10 for grinding an inner surface of a cylindrical tank 12. The cylindrical tank 12 is divided into a cylindrical part 12a, a first convex part 12b and a second convex part (not visible in the present view). The tank 12 is secured by a frame 14. The frame 14 comprises a first member 14a extending outside the cylindrical part 12a of the tank 12, a second member 14b extending outside the cylindrical part 12a of the tank 12 opposite the first member 14a, and a third member 14c interconnecting the first member 14a and the second member 14b at the first convex part 12b.

The frame 14 is connected to a stand 16 through a tilting assembly 18. The tilting assembly has a number of predetermined tilting angles and is located near the centre of gravity of the assembly such that the tank 12 may be easily tilted by hand. The tiling assembly 18 comprises a pivot 18a, a pin configuration 18b connected to the stand 16 and a hole assembly 18c connected to the frame in order for the user to be able to select a tilting angle among a number of angles defined by the number of holes in the hole assembly 18c.

The frame 14 further comprises a chain 20 extending below the cylindrical part 12a of the tank 12 between the first member 14a and the second member 14b. The chain 20 comprises a number of rollers 20a for contacting and supporting the cylindrical part 12a of the tank 12. The frame 14 further comprising an electrical motor 22 and a drive mechanism connected to the centre of the first convex part 12b which at the same time constitutes the interception between the first convex part 12b and the central axis of the cylindrical part 12a of the tank 12. The frame secures the tank 12 and prevents movement of the tank 12 in any direction except about the central axis. The movement of the tank 12 about the central axis as shown by the arrow is caused by the motor 22 and the drive mechanism 24.

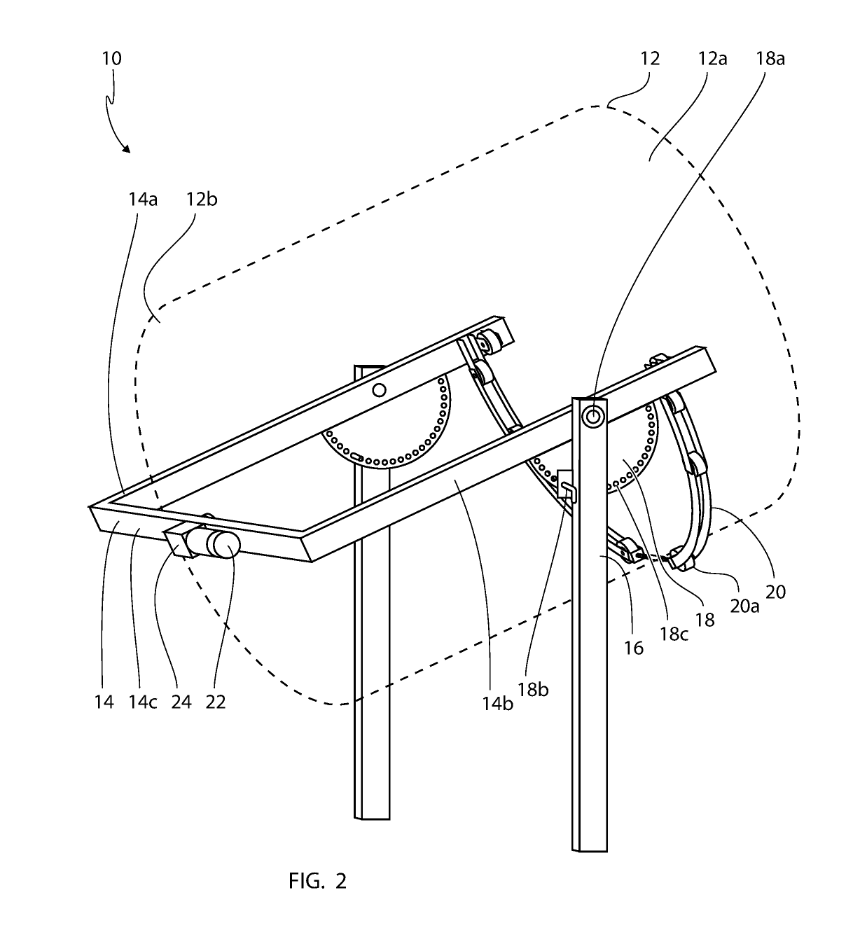

FIG. 2 shows a perspective view of an assembly 10 for grinding an inner surface of a cylindrical tank 12 similar to FIG. 1 except that the tank has been removed revealing the complete first member 14a.

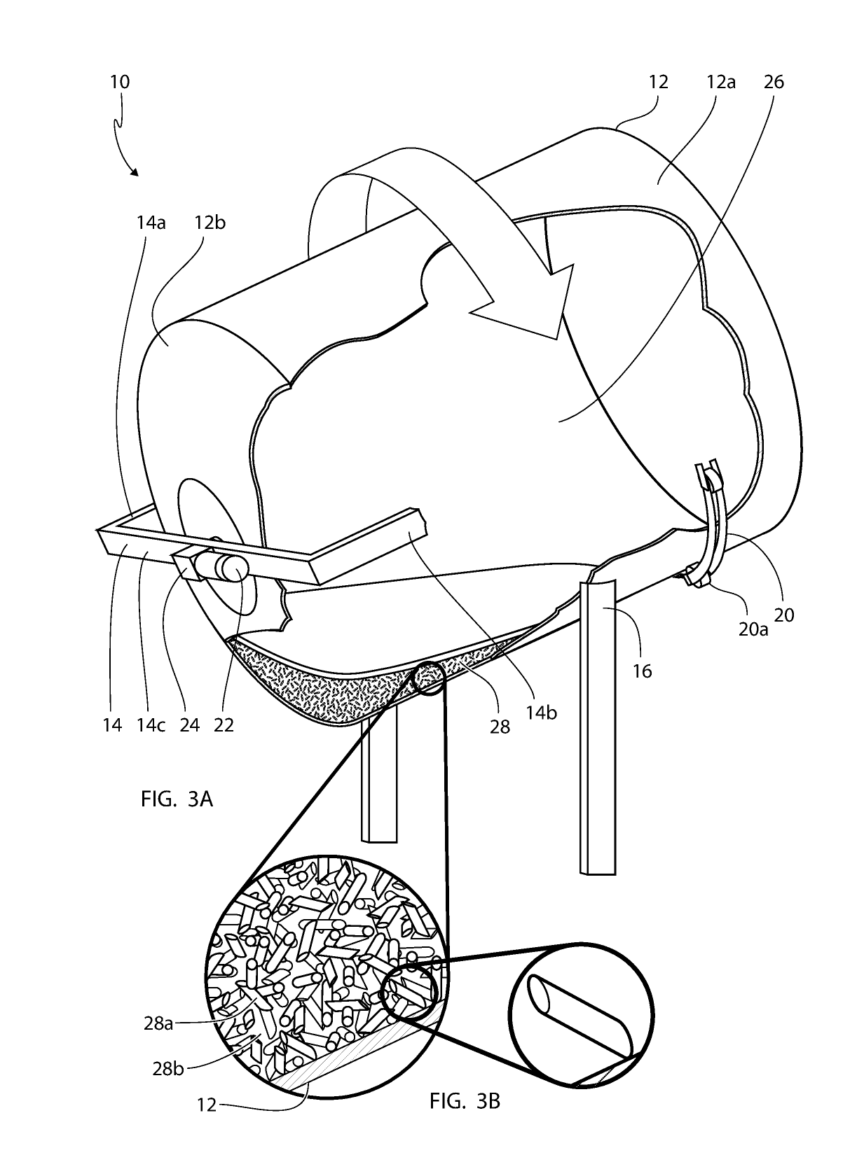

FIG. 3A-3B shows a perspective view of an assembly 10 for grinding an inner surface of a cylindrical tank 12, similar to FIG. 1 except that the present FIG. 3A also shows the interior of the tank 12, exposing the inner surface 26 of the tank 12. The bottom of the tank is filled by a grinding material 28. As can be seen in the first close-up, the grinding material comprises grinding stones 28a in the form of pellets. Further, the grinding stones 28a are covered by an aqueous solution 28b. The aqueous solution 28b comprises a mixture of a soap solution and a weak alkaline solution. As can be seen in the second close-up, the grinding stones 28a have a shape of angle-cut cylinders. The grinding stones 28a have a length of between 2-20 mm and a diameter of 1-10 mm, depending on the size of the tank 12. The tank 12 is then rotated slowly at a rotation speed not exceeding 100 rpm during which the inner surface of the tank is being grinded and polished. The first grinding process using coarse grinding stones 28a lasts for a period of between 3-4 days and the second grinding process using fine grinding stones 28a last for about 5 days. When the process is finished then the inner surface 26 has a roughness (Ra) of less than 0.2 micrometer.

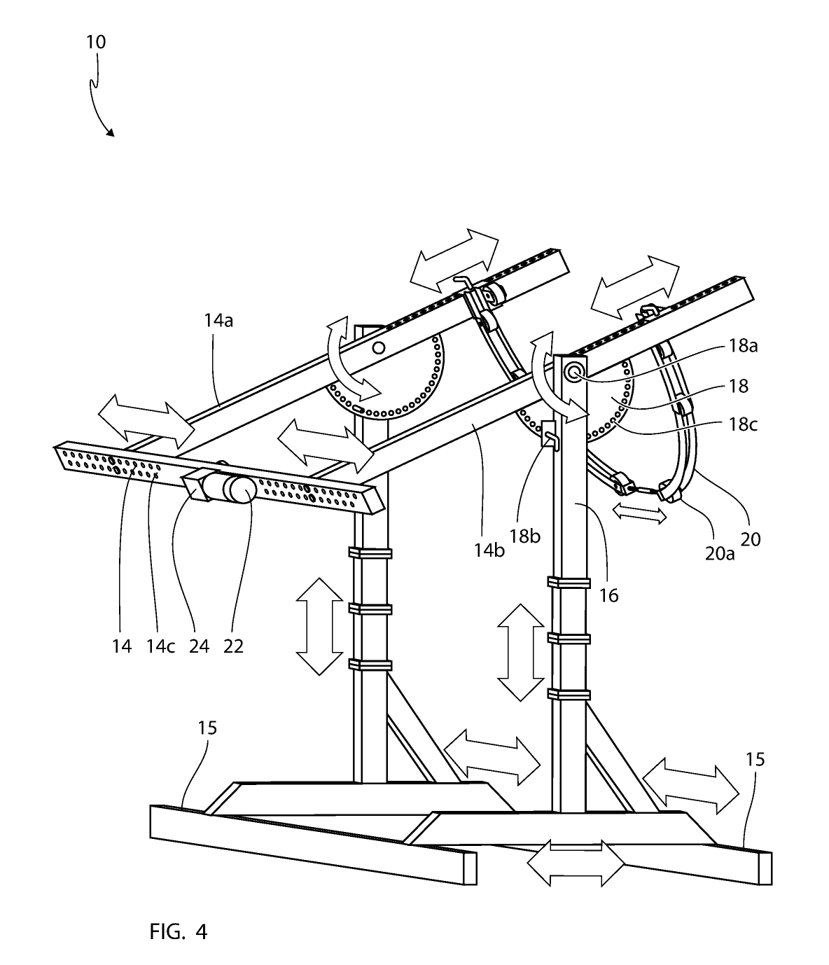

FIG. 4 shows a perspective view of an assembly 10 for grinding an inner surface of a cylindrical tank 12, showing by arrows the degrees of freedom of the frame 14. The first member 14a and the second member 14b are movable relative to the third member 14c thereby allowing the frame 14 to adjust to larger and smaller tanks 12. The length of the chain 20 is adjustable as well as the position of the chain 20 is relative to the first member 14a and the second member 14b. Further, the tilt angle of the frame 14 is adjustable via the tilting assembly 18. Also, the height of the stand 16 is adjustable, and the stand 16 is itself adjustable in relation to the base 15.

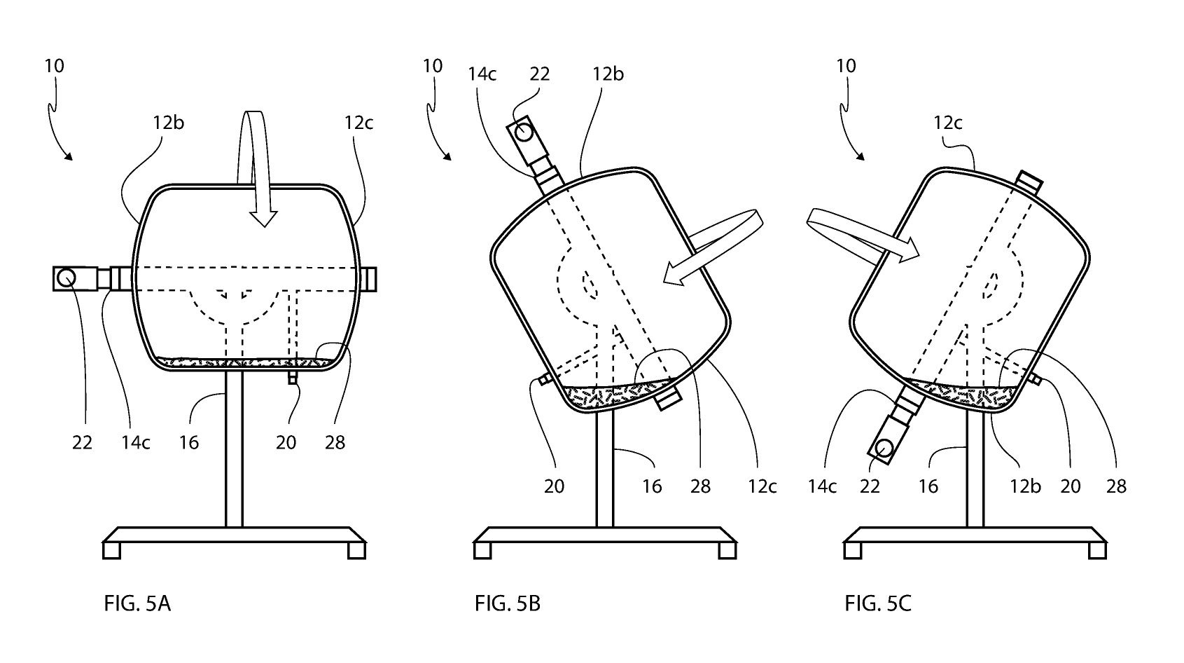

FIGS. 5A, B and C show side views of three respective tilt angles of the frame 14.

FIG. 5A shows the horizontal orientation of the frame 14 and the tank 12. In this position the cylindrical part 12a of the tank 12 is being polished as the grinding material 28 is located on the inner surface adjacent the cylindrical part 12a. As the tank 12 rotates the grinding material 28 remains at the bottom of the tank 12 and the grinding material 28 moves in relation to the inner surface of the tank 12 in a sliding and non-tumbling movement.

FIG. 5B shows the frame 14 and the tank 12 tilted such that the first convex part 12b is facing upwards whereas the second convex part 12c is facing downwards. The grinding material 28 moves to the lower most location which in the present angle is the part of the second convex part 12c between the intersection between the cylindrical part 12a and the second convex part 12c, and, the intersection between the central axis of the cylindrical part 12a and the second convex part 12c. In this configuration the inner surface adjacent the second convex part 12c is ground.

FIG. 5C shows the frame 14 and the tank 12 tilted such that the first convex part 12b is facing downwards whereas the second convex part 12c is facing upwards. The grinding material 28 moves to the lowermost location which in the present angle is the part of the first convex part 12b between the intersection between the cylindrical part 12a and the first convex part 12b, and, the intersection between the central axis of the cylindrical part 12a and the first convex part 12b. In this configuration the inner surface adjacent the first convex part 12b is ground.

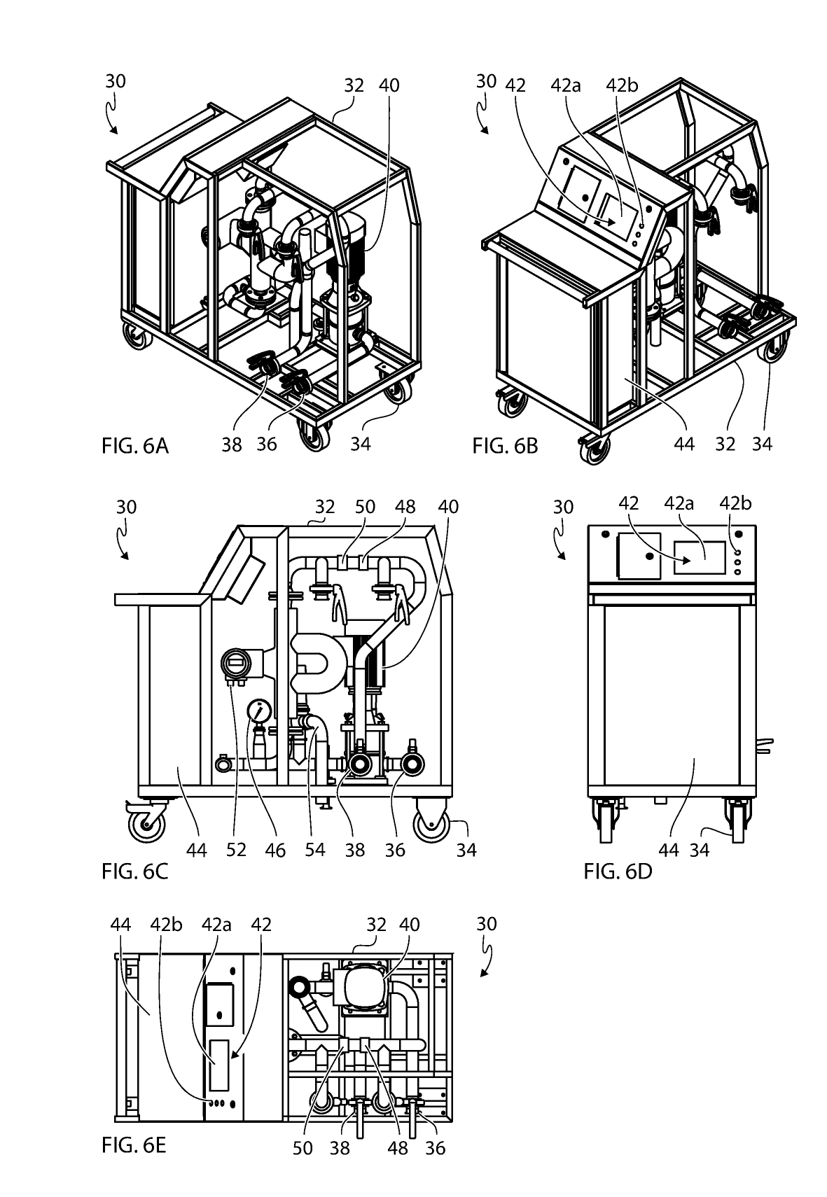

FIG. 6A shows a rear perspective view of a pump trolley 30. The pump trolley 30 comprises an outer casing 32 having a size such that the pump trolley 30 fits through a residential door and is conveniently maneuverable indoors. The casing 32 comprises four swivel wheels 34. The pump trolley 30 comprises a fluid inlet 36 comprising a valve. The inlet 36 is connected to an outlet 38 also provided with a valve. A pump 40 is located between the inlet 36 and the outlet 38.

FIG. 6B shows a front perspective view of a pump trolley 30. The present view reveals a user interface 42 including a screen 42a and control buttons 42b as well as a processing unit 44.

FIG. 6C shows a side view of a pump trolley 30 revealing a pressure measurement device 46, a temperature measurement device 48, a flow measurement device 50, and an optional conductance or pH measurement device 52 is shown. Further, an overpressure valve 54 is shown. All the devices 46, 48, 50 and 52 are connected to the processing unit 44 for logging the data and for control.

FIG. 6D shows a front view of a pump trolley 30.

FIG. 6E shows a top view of a pump trolley 30.

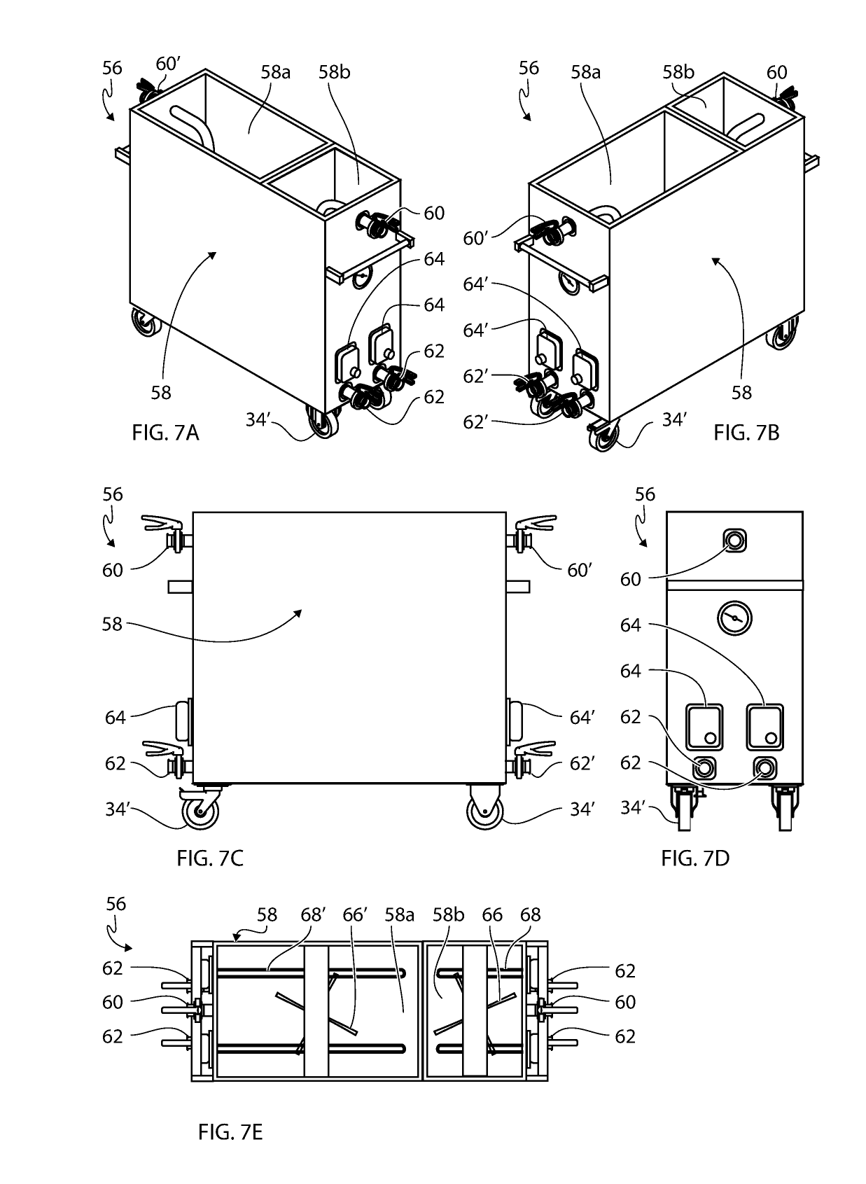

FIG. 7A shows a front perspective view of a tank trolley 56. The tank trolley 56 has a size such that the tank trolley 56 fits through a residential door and is conveniently maneuverable indoors. The tank trolley 56 also comprises four swivel wheels 34′. The tank trolley 56 comprises an inner volume 58 having a total volume of about 100 litres and being divided into a large inner volume 58a and a small inner volume 58b. The tank trolley 56 further comprises an inlet 60 having a valve and communicating with the small inner volume 58b, two outlets 62 each having a valve and communicating with the small inner volume 58b, and a heating system 64 connectable to an AC power source and capable of heating a cleaning fluid within the small inner volume 58b.

FIG. 7B shows a rear perspective view of a tank trolley 56. This view reveals a corresponding inlet 60′, two corresponding outlets 62′ and a corresponding heating system 64′, all communicating with the large inner volume 58a.

FIG. 7C shows a side view of a tank trolley 56.

FIG. 7D shows a front view of a tank trolley 56.

FIG. 7E shows a top view of a tank trolley 56. It reveals heating elements 66 66′ and stirrers 68 68′ inside the respective small inner volume 58a and the large inner volume 58b.

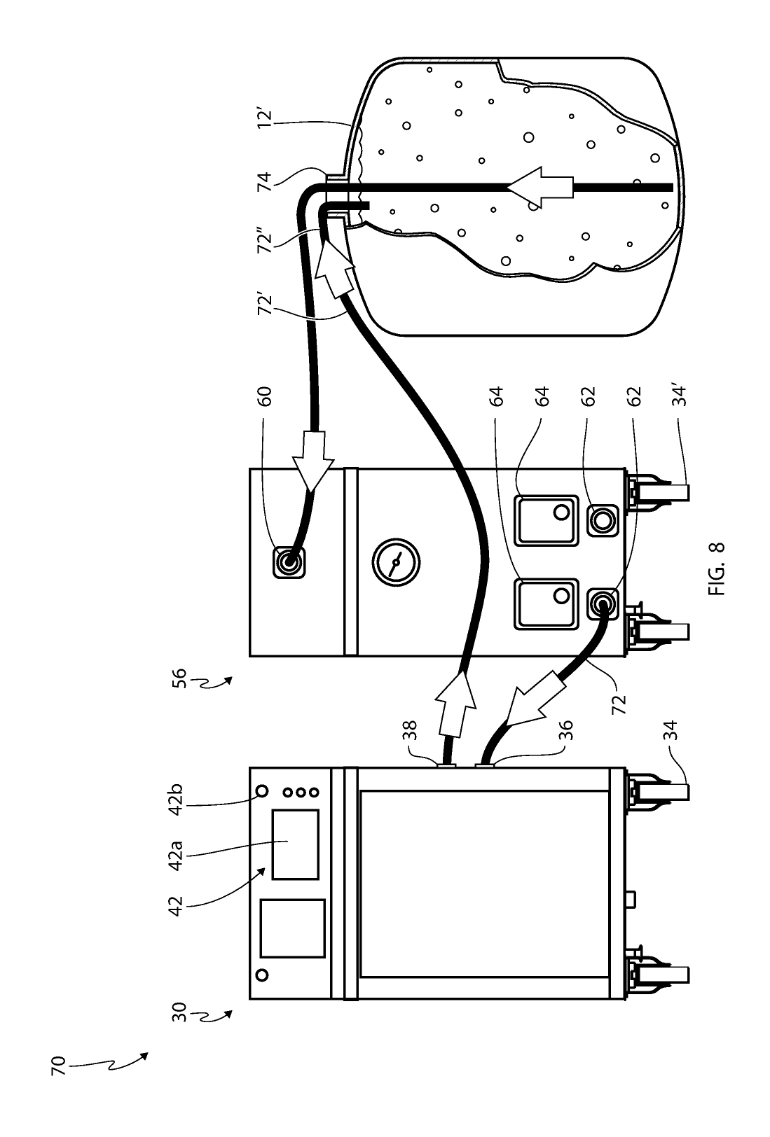

FIG. 8 shows a side view of a cleaning system 70. The cleaning system comprises a tank 12′, a tank trolley 56 and a pump trolley 30. The outlet 62 of the tank trolley 56 is connected to the inlet 36 of the pump trolley 30 via a first line 72. The outlet 38 of the pump trolley 30 is connected to an opening 74 of the tank 12′ via a second line 72′. The opening 74 of the tank is connected to the inlet 60 of the tank trolley 56 via a third line 72″.

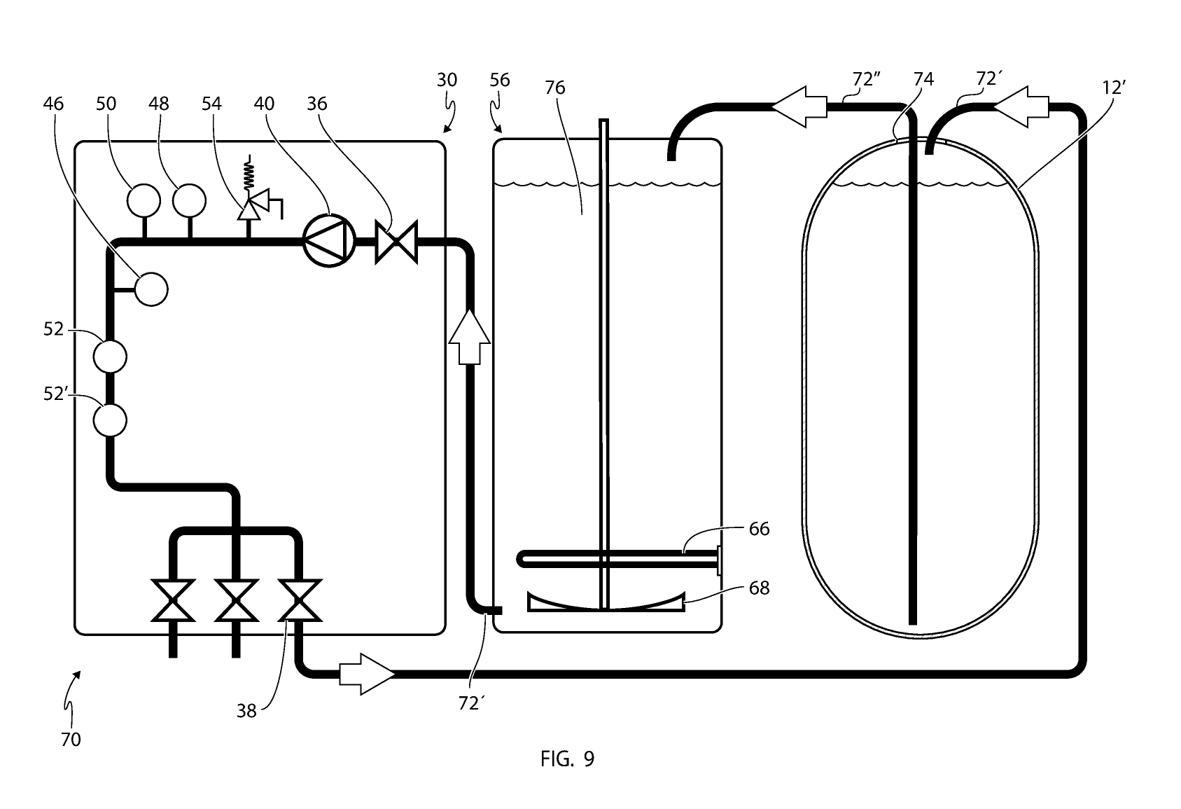

FIG. 9 shows a schematic view of a cleaning system 70. The inner volume 58 of the tank trolley 76 is filled by a cleaning fluid 76. The cleaning fluid 76 may be de-ionised and/or distilled water, a weak alkaline solution, a weak acid solution or a strong acid solution, depending on the type of cleaning to be performed. Water is typically used for flushing after the cleaning and between using the other cleaning fluids. Alkaline solutions, such as NaOH are typically used for degreasing, weak acid solutions such as citric acid for decontamination and strong acid solutions such as HNO₃ for passivation.

The outlet 62 of the tank trolley 56 is connected via a first line 72 to the inlet 36 of the pump trolley 30. The pump trolley 30 comprises a fluid conduit between the inlet 36 and the outlet 38. The fluid conduit comprises a pump 40, an overpressure valve 54 acting as a safety valve in case of over pressurization, a temperature measurement device 48, a flow measurement device 50, a pressure measurement device 46, a conductance measurement device 52 and a pH measurement device 52′. The outlet 36 of the pump trolley 30 is connected via a second line 72′ to the opening 74 tank 12′. A return line 72″ closes the circuit and transports the cleaning fluid from the tank 12′ back to the inner volume 58.

During the cleaning process, the temperature measurement device 48, the flow measurement device 50, the pressure measurement device 46, the conductance measurement device 52 and the pH measurement device 52′ delivers data to the processing unit. The processing unit may be using the data for logging purposes and for controlling the cleaning process. The temperature value may be used for controlling the heating system of the tank trolley 56. The pressure value and the flow value may be used for controlling the pump 40. The flow value and the pH value/conductance value may be used for determining the end of the cleaning process.

### LIST OF PARTS WITH REFERENCE TO THE FIGURES

10. Assembly for grinding an inner surface of a cylindrical tank
12. Cylindrical tank
12a. Cylindrical part
12b. First conical part
12c. Second conical part
14. Frame
14a. First frame member
14b. Second frame member
14c. Third frame member
16. Stand
18. Tilting assembly
18a. Pivot
18b. Pin
18c. Hole assembly
20. Chain
20a. Roller
22. Motor
24. Drive mechanism
26. Inner surface
28. Grinding material
28a. Grinding stones
28b. Aqueous solution
30. Pump trolley
32. Casing
34. Wheels
36. Inlet
38. Outlet
40. Pump
42. User interface
42a. Screen
42b. Button
44. Processing unit
46. Pressure measurement device
48. Temperature measurement device
50. Flow measurement device
52. Conductance or pH measurement device
54. Overpressure valve.
56. Tank trolley
58. Inner volume
58a. Large inner volume
58b. Small inner volume
60. Inlet
62. Outlet
64. Heating system
66. Heating element
68. Stirrer
70. Cleaning system
72. Lines
74. Opening
76. Cleaning fluid

1. A method of grinding an inner surface of a cylindrical tank comprising a convex first part, a convex second part, and a cylindrical part interconnecting said first part and said second part, said first part, said second part, and said cylindrical part together defining said inner surface, said cylindrical part defining a central axis, said method comprising the steps of:
(a) providing a grinding assembly, said assembly comprising:
(1) a frame configured for holding said cylindrical tank so as to prevent substantial movement of said cylindrical tank except around said central axis, said frame comprising a motor and a drive mechanism operably connected to said motor, said drive mechanism being operable for interacting with said cylindrical tank; and
(2) a stand rotatably connected to said frame, said stand defining a tilt axis in relation to said frame, said tilt axis being horizontal and perpendicular to said central axis;
(b) holding said cylindrical tank by said frame and causing said frame to assume a horizontal position in which said first part and said second part are level;
(c) placing an amount of grinding material into said tank such that said grinding material covers a part of said inner surface and extends between said convex first part and said convex second part;
(d) rotating said cylindrical tank about said central axis by using said motor and said drive mechanism at a rotational speed not exceeding 100 rpm and causing said grinding material to move in a sliding and non-tumbling movement relative to said inner surface;
(e) causing said frame to assume a first tilted position in which said first part is located above said second part, and said grinding material extends on said inner surface between said cylindrical part and a first point of interception between said second part and said central axis;
(f) rotating said cylindrical tank about said central axis with said motor and said drive mechanism at a rotational speed not exceeding 100 rpm and causing said grinding material to move in a sliding and non-tumbling movement relative to said inner surface;
(g) causing said frame to assume a second tilted position in which said first part is located below said second part, and said grinding material extends on said inner surface between said cylindrical part and a second point of interception between said first part and said central axis; and
(h) rotating said cylindrical tank about said central axis with said motor and said drive mechanism at a rotational speed not exceeding 100 rpm, and causing said grinding material to move in a sliding and non-tumbling movement relative to said inner surface.

2. The method according to claim 1, wherein said motor and said drive mechanism are operable for rotating said cylindrical tank at 5-100 rpm.

3. The method according to claim 1, wherein said grinding material comprises a mixture of ceramic grinding stones and an aqueous solution.

4. The method according to claim 3, wherein said ceramic grinding stones have a shape corresponding to angle-cut cylinders having a length of between 2-20 mm and a diameter of 1-10 mm.

5. The method according to claim 3, wherein said aqueous solution comprises a mixture of a soap solution and an alkaline solution.

6. The method according to claim 3, wherein said amount of grinding material is chosen such that said aqueous solution covers said ceramic grinding stones within said cylindrical tank.

7. The method according to claim 3, wherein said amount of grinding material is chosen such that said grinding material covers an angular distance perpendicular to said longitudinal distance on said inner surface of said cylindrical part of between 10°-120°.

8. The method according to claim 1, wherein said frame further comprising a chain, said chain comprising rollers configured for supporting said cylindrical tank.

9. The method according to claim 1, wherein said stand and said frame define a number of predefined angles in relation to each other.

10. The method according to claim 1, wherein said frame is adjustable in length and width.

11. An assembly for grinding an inner surface of a cylindrical tank, said cylindrical tank comprising a convex first part, a convex second part, and a cylindrical part interconnecting said first part and said second part, said first part, said second part, and said cylindrical part together defining said inner surface, said cylindrical part defining a central axis, said assembly comprising:
a frame configured for holding said cylindrical tank so as to prevent substantial movement of said cylindrical tank except around said central axis, said frame comprising a motor and a drive mechanism operably connected to said motor, said drive mechanism being operable for interacting with said cylindrical tank for rotating said cylindrical tank about said central axis at a rotational speed not exceeding 100 rpm; and
a stand rotatably connected to said frame, said stand defining a tilt axis in relation to said frame, said tilt axis being horizontal and perpendicular to said central axis, said stand allowing said frame to assume a horizontal position in which said first part and said second part are level, a first tilted position in which said first part is located above said second part, and a second tilted position in which said first part is located below said second part.

12. A mobile system for cleaning a vessel, such as a tank or pipeline, with a cleaning fluid, said system comprising:
a first trolley comprising an internal reservoir dimensioned to hold a volume of cleaning fluid, and a fluid connector configured for connecting to said internal reservoir from outside of said first trolley, said first trolley further comprising a heating system operable for heating any cleaning fluid that may be contained within said internal reservoir;
a second trolley comprising a conduit with a fluid inlet having an inlet valve and connectable to said fluid connector of said first trolley, and a fluid outlet having an outlet valve and connectable to said vessel, said conduit comprising a pump connected to said fluid inlet and operable for pumping cleaning fluid from said internal reservoir of said first trolley via said fluid inlet and fluid outlet to said vessel, said second trolley further comprising a relief valve configured for relieving said conduit of any excessive pressures, a pressure measurement device operable for measuring the pressure within said conduit, a temperature measurement device operable for measuring the temperature within said conduit, a flow measurement device operable for measuring the flow of cleaning fluid through said conduit, and a processing unit for receiving said measured pressure, temperature and flow,
each of said first trolley and said second trolley having at least 2 wheels, and each of said first trolley and said second trolley having a height and a width less than the height and width, respectively, of a standard residential door.

13. The system according to claim 12, wherein said second trolley further comprises a conductance measurement device operable for measuring the conductance of said cleaning fluid.

14. The system according to claim 12, wherein said second trolley further comprises a pH measurement device operable for measuring the pH of said cleaning fluid.

15. The system according to claim 12, wherein said internal reservoir is made up of at least two separate compartments having separate fluid connectors and heating systems, at least a first one of said compartments being larger than at least a second one of said compartments

16. The system according to claim 12, wherein said internal reservoir includes a stirrer.

17. A process of cleaning a vessel, such as a tank or a pipeline, said process comprising:
(a) providing a first trolley comprising an internal reservoir containing a volume of cleaning fluid, and a fluid connector connecting to said internal reservoir from outside of said first trolley, said first trolley further comprising a heating system operable for heating said cleaning fluid within said internal reservoir;
(b) providing a second trolley comprising a conduit between a fluid inlet having an inlet valve and connected to said fluid connector of said first trolley, and a fluid outlet having an outlet valve and connected to said vessel, said conduit comprising a pump connected to said fluid inlet, said second trolley further comprising a relief valve operable for relieving said conduit of any excessive pressures, a pressure measurement device operable for measuring the pressure within said conduit, a temperature measurement device operable for measuring the temperature within said conduit, a flow measurement device operable for measuring the flow of cleaning fluid through said conduit, and a processing unit operable for receiving said measured pressure, temperature and flow, each of said first trolley and said second trolley having at least 2 wheels, and each of said first trolley and said second trolley having a height and a width being less than the height and width, respectively, of a standard residential door; and
(c) pumping cleaning fluid from said internal reservoir of said first trolley via said fluid inlet and fluid outlet to said vessel using said pump.
